(19) United States
(12) Patent Application Publication
(10) Pub. No.: US 2006/0098347 A1
(43) Pub. Date: May 11, 2006

(54) Micro-actuator, head gimbal assembly and disk drive unit with the same

(75) Inventors: MingGao Yao, DongGuan (CN); YiRu Xie, DongGuan (CN); Masashi Shiraishi, HongKong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 10/985,008

(22) Filed: Nov. 10, 2004

(51) Int. Cl. G11B 5/56

(52) U.S. Cl. 360/294.4

(57) ABSTRACT

A HGA includes a slider; a micro-actuator comprising a bottom plate, a moving plate, and two arm plates symmetrically disposed with an axis of the bottom plate as symmetry axis to connect the moving plate and the bottom plate; and at least one piezoelectric pieces to be bonded to the arm plates; and a suspension to load the slider and the micro-actuator. The slider is mounted on and rotated by the moving plate when exciting the at least one piezoelectric pieces. The invention also discloses a structure of the disk drive unit.

### FIELD OF THE INVENTION

The present invention relates to disk drive units, and particularly relates to a micro-actuator, and a head gimbal assembly using the micro-actuator.

### BACKGROUND OF THE INVENTION

Disk drives are information storage devices that use magnetic media to store data. Referring to FIG. 1a, a typical disk drive in related art has a magnetic disk and a drive arm to drive a head gimbal assembly 277 (HGA) (the HGA 277 has a suspension (not labeled) with a slider 203 mounted thereon). The disk is mounted on a spindle motor which causes the disk to spin and a voice-coil motor (VCM) is provided for controlling the motion of the drive arm and thus controlling the slider 203 to move from track to track across the surface of the disk to read data from or write data to the disk.

However, Because of the inherent tolerance resulting from VCM and the suspension that exists in the displacement (off track) of the slider 203, the slider 203 can not attain a fine position control which will affect the slider 203 to read data from and write data to the magnetic disk.

To solve the above-mentioned problem, piezoelectric (PZT) micro-actuators are now utilized to modify the displacement of the slider 203. That is, the PZT micro-actuator corrects the displacement of the slider 203 on a much smaller scale to compensate for the resonance tolerance of the VCM and the suspension. It enables a smaller recording track width, increases the ‘tracks per inch’ (TPI) value by 50% of the disk drive unit (it is equivalent to increase the surface recording density).

Referring to FIG. 1b, a traditional PZT micro-actuator 205 comprises a ceramic U-shaped frame 297 which comprises two ceramic beams 207 with two PZT pieces (not labeled) on each side thereof. With reference to FIGS. 1a and 1b, the PZT micro-actuator 205 is physically coupled to a suspension 213, and there are three electrical connection balls 209 (gold ball bonding or solder ball bonding, GBB or SBB) to couple the micro-actuator 205 to the suspension traces 210 in each one side of the ceramic beam 207. In addition, there are four metal balls 208 (GBB or SBB) to couple the slider 203 to the suspension 213 for electrical connection. FIG. 1c shows a detailed process of inserting the slider 203 into the micro-actuator 205. The slider 203 is bonded with the two ceramic beams 207 at two points 206 by epoxy dots 212 so as to make the motion of the slider 203 dependent of the ceramic beams 207 of the micro-actuator 205.

When power supply is applied through the suspension traces 210, the PZT pieces of the micro-actuator 205 will expand or contract to cause two ceramic beams 207 of the U-shaped frame 297 deform and then make the slider 203 move on the track of the disk. Thus a fine head position adjustment can be attained.

However, because the PZT micro-actuator 205 and the slider 203 are mounted on the suspension tongue (not labeled), when the PZT micro-actuator 205 is excited, it will do a pure translational motion to sway the slider 203 due to the constraint of U-shaped frame 297 of the micro-actuator 205, and cause a suspension vibration resonance which has a same frequency as the suspension base plate. This will limit the servo bandwidth and the capacity improvement of HDD. As shown in FIG. 2, numeral 201 represents a resonance curve when shaking the suspension base plate and numeral 202 represents a resonance curve when exciting the micro-actuator 205. The figure clearly shows the above-mentioned problem.

Additionally, the micro-actuator 205 has an additional mass which not only influence the static performance, but also influence the dynamic performance of the suspension 213, such as the resonance performance, so as to reduce resonance frequency and increase the gain of the suspension 213.

Hence, it is desired to provide a micro-actuator, HGA, disk drive to solve the above-mentioned problems.

### SUMMARY OF THE INVENTION

A main feature of the present invention is to provide a micro-actuator and a HGA which can attain a fine head position adjustment and a good resonance performance when exciting the micro-actuator.

Another feature of the present invention is to provide a disk drive unit with big servo bandwidth and head position adjustment capacity.

To achieve the above-mentioned features, a HGA of the present invention comprises a slider; a micro-actuator having a bottom plate, a moving plate, and two arm plates symmetrically disposed with an axis of the bottom plate as symmetry axis to connect the moving plate and the bottom plate; and at least one piezoelectric pieces to be bonded to the arm plates; and a suspension to load the slider and the micro-actuator; wherein the slider is mounted on and rotated by the moving plate when exciting the at least one piezoelectric pieces.

In an embodiment, the moving plate comprises a support portion to support the slider, and two connection portions to connect with the support portion along a diagonal thereof. Each of the two connection portions has a narrower width than that of the support portion. The slider is partially mounted on the support portion of the support frame; and the centers of the slider and the support portion are well matched. In another embodiment, two connection portions are coupled with the two arm plates by two coupling points, which is symmetrically positioned with a longitude axis of the support frame as symmetry axis. The distance between the two arm plates is larger than the width of the slider so that two gaps formed therebetween. In the present invention, the bottom plate is partially mounted to the suspension, and a parallel gap exists between the support frame and the suspension. The arm plates are formed on two sides of both the bottom plate and the moving plate, and at least a space exist between the arm plate and the bottom plate or between the arm plate and the moving plate. The at least one PZT pieces are mounted on one side or both sides of each of the arm plates. The material to bond the slider with the support frame and the material to bond the bottom plate of the support frame with the suspension is epoxy, adhesive or ACF.

A micro-actuator of the present invention comprises a bottom plate; a moving plate for loading and rotating a slider; two arm plates symmetrically disposed with an axis of the bottom plate as symmetry axis to connect the moving plate and the bottom plate; and at least one piezoelectric pieces bonded to the two arm plates. In an embodiment, the moving plate comprises a support portion to support a slider, and two connection portions to connect with the support portion along a diagonal thereof. Each of the two connection portions has a narrower width than that of the support portion. The at least one piezoelectric pieces are thin film piezoelectric pieces or ceramic piezoelectric pieces, which have a single-layer structure or a multi-layer structure comprising a substrate layer and a piezoelectric layer. The piezoelectric layer may be a single-layer PZT structure or a multi-layer PZT structure, the substrate layer is made of metal, ceramic, or polymer. In the present invention, the arm plates are formed on two sides of both the bottom plate and the moving plate, and at least a space exist between the arm plate and the bottom plate or between the arm plate and the moving plate. The at least one PZT pieces are mounted on one side or both sides of each of the arm plates. The material to bond the slider with the support frame is epoxy, adhesive or ACF.

A disk drive unit of the present invention comprises a HGA; a drive arm to connect with the HGA; a disk; and a spindle motor to spin the disk; wherein HGA comprises a slider; a micro-actuator comprising a bottom plate, a moving plate, and two arm plates symmetrically disposed with an axis of the bottom plate as symmetry axis to connect the moving plate and the bottom plate; and at least one piezoelectric pieces to be bonded to the arm plates; and a suspension to load the slider and the micro-actuator; wherein the slider is mounted on and rotated by the moving plate when exciting the at least one piezoelectric pieces; the bottom plate is partially mounted on the suspension and a parallel gap exist between the support frame and the suspension therein.

Compared with the prior art, the micro-actuator utilizes PZT pieces to bend the arm plates and then rotate the moving plate of the support frame so as to rotate the slider because the slider is partially mounted on the moving plate. The two connection portions of the support frame prevent the slider from lateral movement, while permitting the slider rotate about its center together with the moving plate for its narrow width. Since the center of the moving part are matched with the center of the slider, the slider can servo without exciting the HGA sway mode.

In the present invention, both trailing side and leading side of the slider can be rotated in different directions so as to make the slider get a bigger moving range. Since the slider is rotated around its center, accordingly, a big head position adjustment capacity and a widely servo bandwidth can be achieved. Generally, a micro-actuator that adjusts a slider by rotating method can be three times as efficient as one that adjust a slider by translation method (e.g. the prior design). The micro-actuator of this invention adjusts the slider by rotating method which is free of translation, so it will be three times as efficient as the prior design. In addition, because the width of the slider is narrower than the distance of two arm plates so that two parallel gaps are formed therebetween, when the micro-actuator is excited, the slider will be rotated more freely and in a large range. Furthermore, a suspension resonance has not happened in a low frequency, but only a pure micro-actuator resonance happened in a high frequency, this would enlarge the servo bandwidth and then improve the capacity of the HDD. Finally, the structure of the micro-actuator will attain a good shock performance comparing with the U-shaped ceramic frame.

For the purpose of making the invention easier to understand, several particular embodiments thereof will now be described with reference to the appended drawings in which:

### DESCRIPTION OF THE DRAWINGS

FIG. 1a is a perspective view of a HGA of related art;

FIG 1b is an enlarged, partial view of FIG. 1a;

FIG. 1c shows a detailed process of inserting a slider to a micro-actuator of the HGA in FIG. 1a;

FIG. 2 shows a resonance curve of the HGA of FIG. 1a;

FIG. 3 is a perspective view of a HGA according to a first embodiment of the present invention;

FIG. 4 is an enlarged, partial view of the HGA of FIG. 3;

FIG. 5 is an exploded view of FIG. 4;

FIG. 6 is a partial, side view of the HGA of FIG. 3;

FIG. 7 is a perspective view of a micro-actuator with a slider mounted thereon according to FIG. 3;

FIG. 8 show an initial status of the micro-actuator with the slider of FIG. 7 when no voltage is applied thereto;

FIG. 9a shows an electrical connection relationship of two PZT pieces of the micro-actuator of FIG. 8, which have a same polarization direction according to an embodiment of the present invention;

FIG. 9b shows an electrical connection relationship of two PZT pieces of the micro-actuator of FIG. 8, which have opposing polarization directions according to another embodiment of the present invention;

FIG. 9c shows two waveforms of voltages which are applied to the two PZT pieces of FIG. 9b, respectively;

FIG. 9d shows a waveform of voltage which is applied to the two PZT pieces of FIG. 9a, respectively;

FIGS. 10 and 11 show two different operation methods of the micro-actuator with the slider of FIG. 8 when being excited;

FIG. 12 shows a resonance curve of the HGA of FIG. 3;

FIGS. 13-15 are perspective views of different support frames of the micro-actuator according to three embodiments of the invention;

FIGS. 16-18 are schematic views of different micro-actuators according to three embodiments of the invention; and

FIG. 19 is perspective view of a disk drive unit according to an embodiment of the invention.

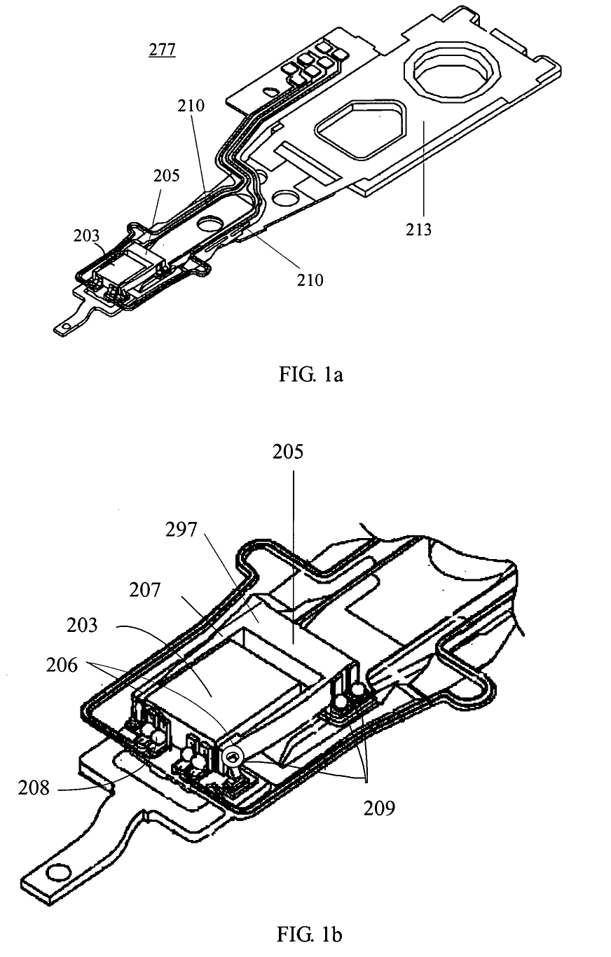

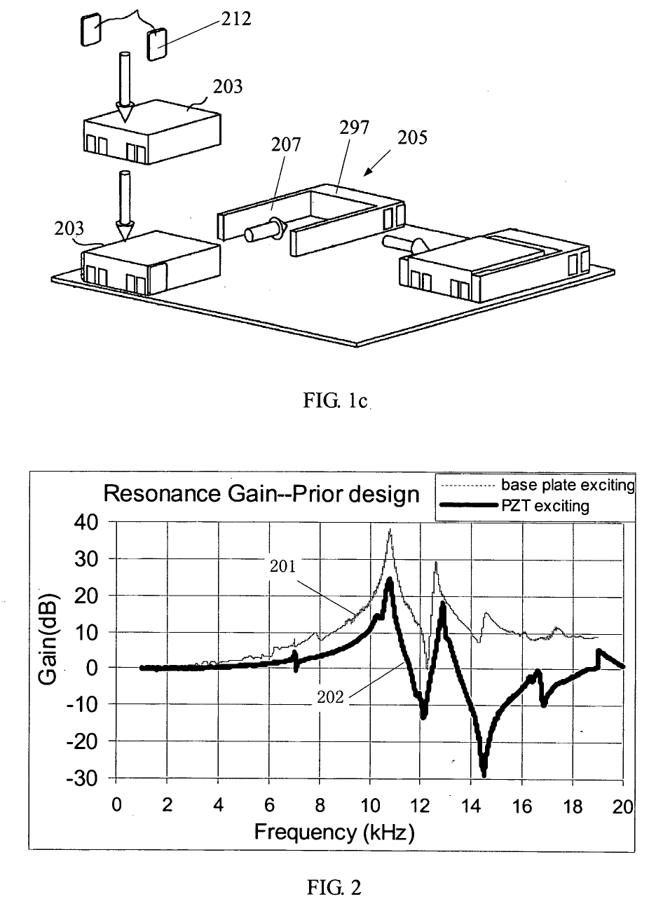

### DETAILED DESCRIPTION OF THE INVENTION

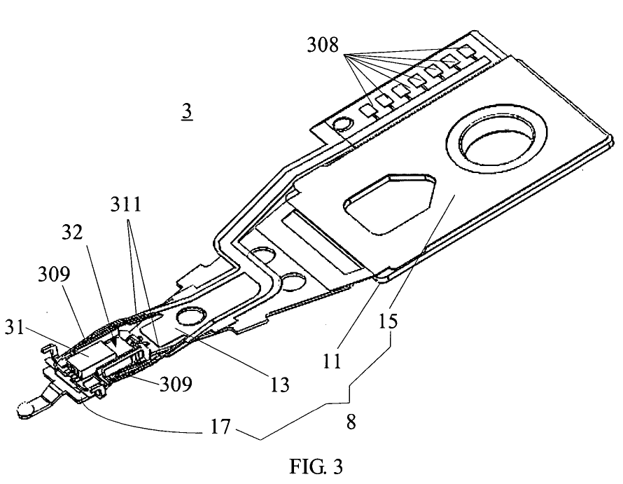

Referring to FIG. 3, a head gimbal assembly (HGA) 3 of the present invention comprises a slider 31, a micro-actuator 32 and a suspension 8 to load the slider 31 and the micro-actuator unit 32.

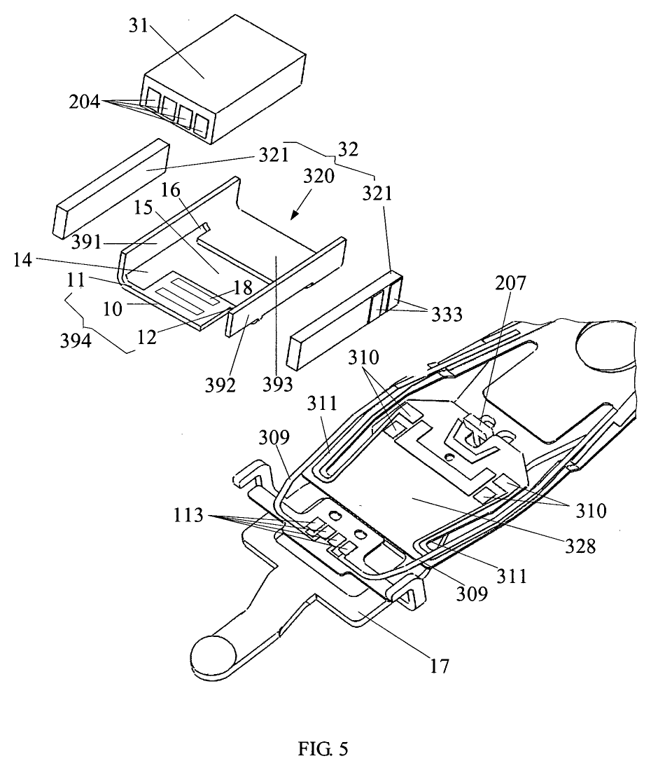

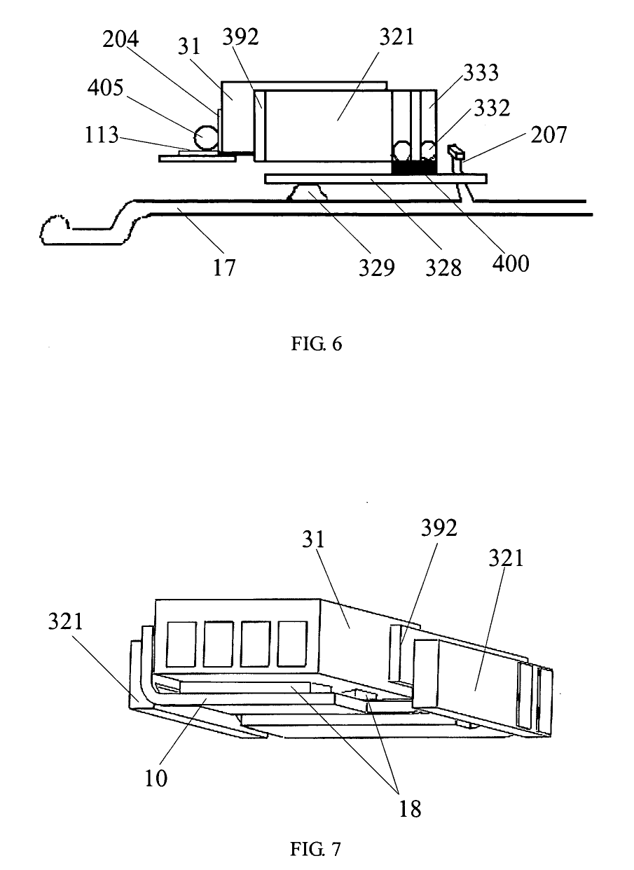

Referring to FIGS. 3-5, the suspension 8 comprises a load beam 17, a flexure 13, a hinge 15 and a base plate 11. The load beam 17 has a dimple 329 (see FIG. 6) formed thereon. On the flexure 13 a plurality of connection pads 308 are provided to connect with a control system (not shown) at one end and a plurality of electrical multi-traces 309, 311 is provided in the other end. The flexure 13 also comprises a suspension tongue 328 which are used to support the micro-actuator 32 and the slider 31, and keep the loading force always being applied to the center area of the slider 31 through the dimples 329 of the load beam 17. The suspension tongue 328 has a plurality of electrical bonding pads 113 and 310 formed thereon. The slider 31 has a plurality of electrical bonding pads 204 on an end thereof corresponding to the electrical bonding pads 113 of the suspension tongue 328.

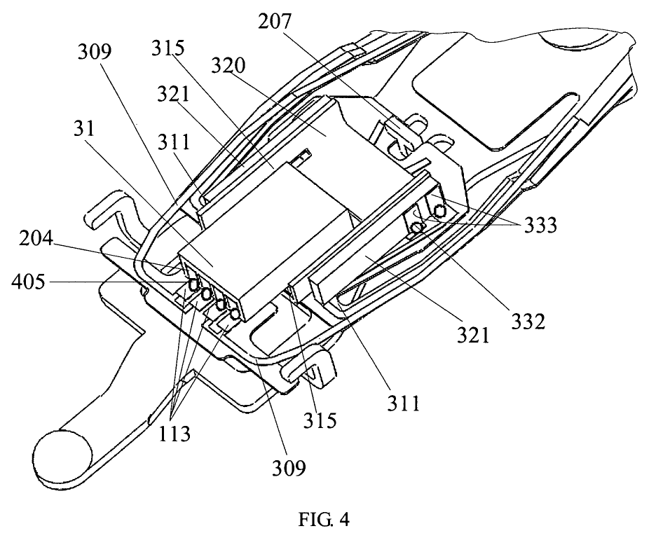

Referring to the FIGS. 4-5, according to an embodiment of the invention, the micro-actuator 32 comprises a support frame 320 and two PZT pieces 321. Each of the PZT pieces 321 has a plurality of electrical bonding pads 333 thereon corresponding to the electrical bonding pads 310 of the suspension tongue 328. The support frame 320 can be made of metal (i.e. stainless steel), ceramic or polymer, which comprises a bottom plate 393, a moving plate 394, and two side plates 391, 392. The side plates 391, 392 are symmetrically disposed with an axis of the bottom plate 393 as symmetry axis, each of which is connected with the bottom plate 393 and the moving plate 394. In the embodiment, the distance between the side plates 391, 392 is larger than the width of the slider 31, when the slider 31 is mounted in the support frame 320, two gaps 315 are thus formed between the support frame 320 and the slider 31. In addition, the moving plate 394 comprises a support portion 10 for supporting the slider 31, and two connection portions 11 and 12 to connect with the support portion 10 by two end portions on a diagonal of the support portion 10. Each of the connection portions 11, 12 has a narrower width than that of the support portion 10, thus a notch 14 is formed between the side plate 391 and the support portion 10, and a cut (not labeled) is formed between the side plate 392 and the support portion 10. In order to increase the elasticity of the support frame 320, two notches 16 can be formed between the bottom plate 393 and the side plate 391, 392. In the embodiment, the support portion 10 is cuboid-shaped, with which the connection portions 11 and 12 vertically connects.

Referring to FIGS. 4-5, a limiter 207 is formed on the load beam 17 which extends through the suspension tongue 328 for preventing the suspension tongue 328 from being bent overly during normal operation of disk drive or any shock or vibration happening to the disk drive. In the invention, the bonding method of the PZT pieces 321 with the support frame 320 can be traditional bonding method, such as epoxy bonding, anisotropic conductive film (ACF) bonding. The two PZT pieces 321 are preferably made of thin film PZT material which can be a single-layer PZT element or a multi-layer PZT element. As an embodiment, each of the PZT pieces 321 has a multi-layer structure, which comprises an inner substrate layer and an outer PZT layer. The substrate layer can be made of ceramic, polymer or metal. The out PZT layer can be a single-layer PZT element or a multi-layer PZT element.

Referring to FIGS. 3-8, the two PZT pieces 321 are bonded with the support frame 320 to form the micro-actuator 32; then, the slider 31 is coupled with the support portion 10 of the micro-actuator 32; after that, the slider 31 and the micro-actuator 32 are mounted on the suspension 8 to form the HGA 3 as follows: firstly, the support frame 320 is partially coupled with the suspension tongue 328 of the flexure 13 by ACF, adhesive or epoxy and keep a parallel gap between the support frame 320 and the suspension tongue 328; then, a plurality of metal balls 332 (GBB or SBB) are used to electrically connect the electrical bonding pads 333 of the two PZT pieces 321 with the electrical bonding pads 310 of the suspension tongue 328 so as to electrically connect the micro-actuator 32 with the two electric multi-traces 311 of the suspension 8. Simultaneously, a plurality of metal balls 405 are used to electrically connect the electrical bonding pads 204 of the slider 31 with the electrical bonding pads 113 so as to electrically connect the slider 31 with the electric multi-traces 309. Through the electric multi-traces 309, 311, the connection pads 308 electrically connect the slider 31 and the micro-actuator 32 with the control system (not shown). Obviously, the assembly of the HGA 3 can also be performed as follows: firstly, coupling the micro-actuator 32 with the suspension 8, and then mounting the slider on the micro-actuator 32.

Referring to FIGS. 5 and 7, the slider 31 is partially coupled with the support portion 10 by two epoxy bars 18, and the centers of the slider 31 and the support portion 10 are well matched. In an embodiment, the two epoxy bars 18 are symmetrically positioned on two ends of the support portion 10 with the center thereof as symmetry point.

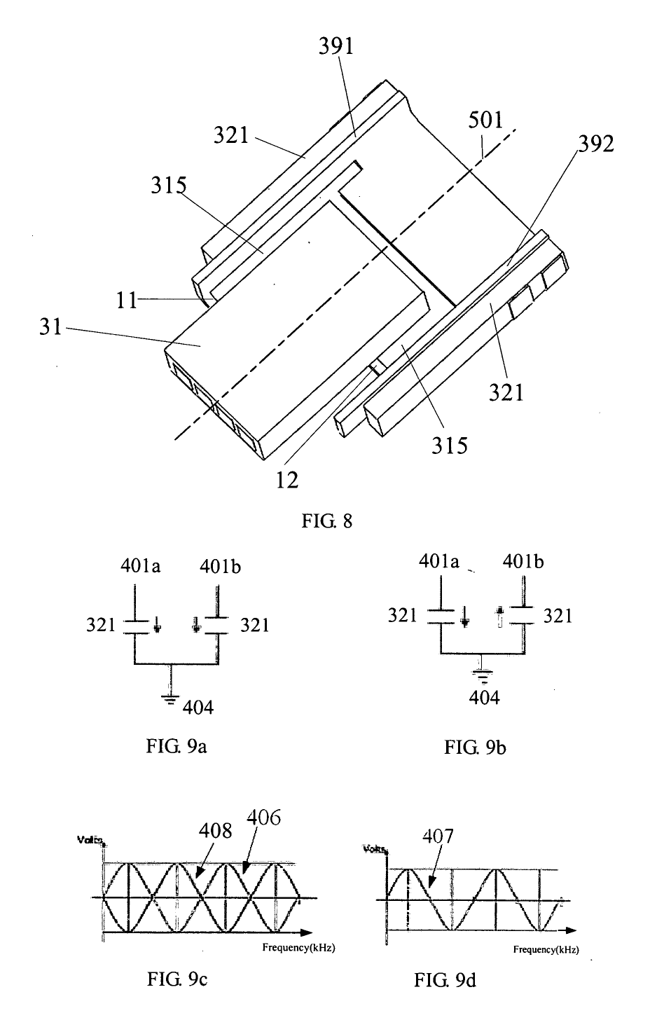

FIGS. 8, 9a, 9d and 10 show a first operation method of the micro-actuator 32 for performing a position adjustment function. In the embodiment, the two PZT pieces 321 have a same polarization direction, as shown in FIG. 9a, which are common grounded by one end 404 and the other ends 401a and 401b thereof are applied two voltages with a same sine waveform 407 (see FIG. 9d). FIG. 8 shows an initial stage of the micro-actuator 32 when no voltage is applied thereto. When the sine voltage 407 is applied to the two PZT pieces 321, in a first half period, both the PZT pieces 321 will contract gradually till to a shortest position (corresponding to a largest displacement position) with the voltage increasing, and then gradually spring back till back to its original location with the voltage reducing.

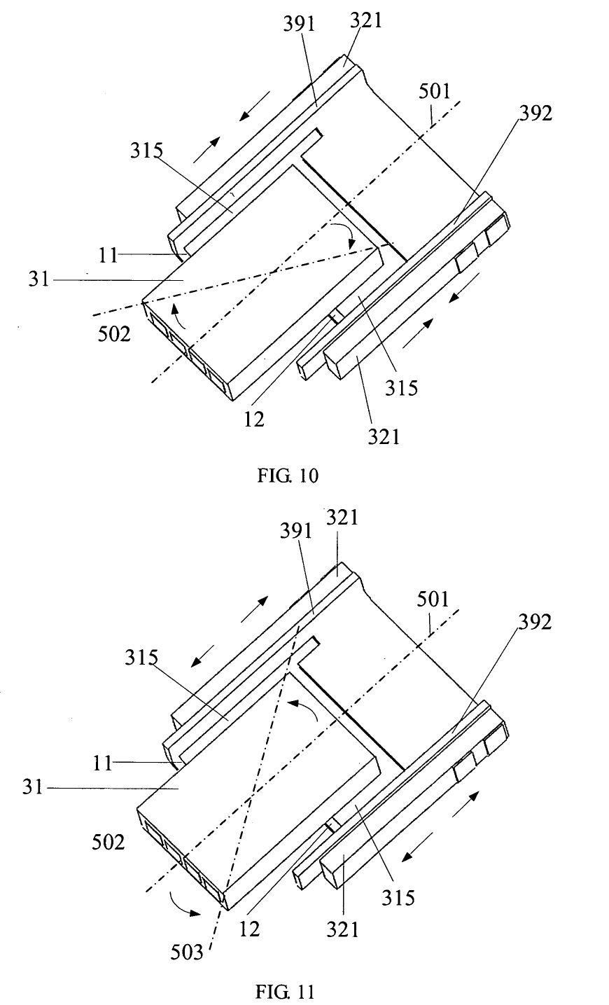

Also referring to FIGS. 10 and 7, when the two PZT pieces 321 both contract, they will bend the two side plates 391 and 392, and then drive the two connection portions 11, 12 of the moving part 394 to move in contrary directions. Because the two connection portions 11, 12 connect with the support portion 10 along a diagonal thereof, and each of which has a narrower width than that of the support portion 10, the support portion 10 will rotate around its center from an original position 501 to a largest displacement position 502, and then return back to the original position 501 under action of the rotate torque generating from the two connection portions 11, 12. Accordingly, because the slider 31 is partially coupled with the support portion 10 by two epoxy bars 18, and the centers of the slider 31 and the support portion 10 are well matched, so the slider 31 will rotate around its center with the support portion 10 from the original position 501 to the largest displacement position 502, and then return back to the original position 501. In addition, two gaps 315 is formed between the slider 31 and the support frame 320 to assure a freely rotation of the slider 31.

Referring to FIGS. 8, 9a, 9d and 11, when the drive voltage 407 goes down to a second half period (having an opposed phase with the first half period), the two PZT pieces 321 both will expand gradually till to a biggest displacement position with the negative voltage increasing, and then gradually back to its original location with the negative voltage reducing until to zero. Accordingly, it will cause the slider 31 to rotate from the original position 501 to a largest displacement location 503, and then back to its original location. Here, because the slider 31 is caused to rotate about its center and thus a head position fine adjustment is attained.

FIGS. 8, 9b, 9c and 10-11 show another operation method of the two PZT pieces 321 for performing head position adjustment function. In the embodiment, the two PZT pieces 321 have two opposing polarization directions, as shown in FIG. 9b, which are also common grounded by one end 404 and the other ends 401a and 401b thereof are applied to two voltages with different phase waveforms 406, 408 (see FIG. 9c). Under the drive of the voltages, both PZT pieces 321 will contract gradually to a shortest position and then back to its initial position during a same half period, and when the voltages go to next half period, both PZT pieces 321 will expand to a longest position and then back to its initial position. Similarly, the slider 31 is thus circularly rotate about its center to attain a head position fine adjustment.

In the present invention, because each of the connection portions 11, 12 has a narrower width than that of the support portion 10 of the support frame 32, so it can assist the rotation of the support portion 10 and the slider 31, that is, the narrow width can cause the connection portions 11, 12 to be easily bent so as to drive the support portion 10 and the slider 31 to rotate. In addition, referring to FIG. 6, a parallel gap formed between the moving plate 394 and the suspension tongue 328 will make the support portion 10 and the slider 31 rotate more freely when being driven by the PZT pieces 321.

Compared with the prior art, the micro-actuator 32 of the invention rotates the slider 31 with its center as a rotation center by using two PZT pieces 321 to rotate a moving plate thereof so as to move both trailing side and leading side of the slider 31 in different directions, while the micro-actuator of the prior art can only move trailing side of the slider like a swing (because its leading side is fixed). So, the present invention can make the slider do fine position adjustment more effective than the prior art. Accordingly, a big head position adjustment capacity can be attained.

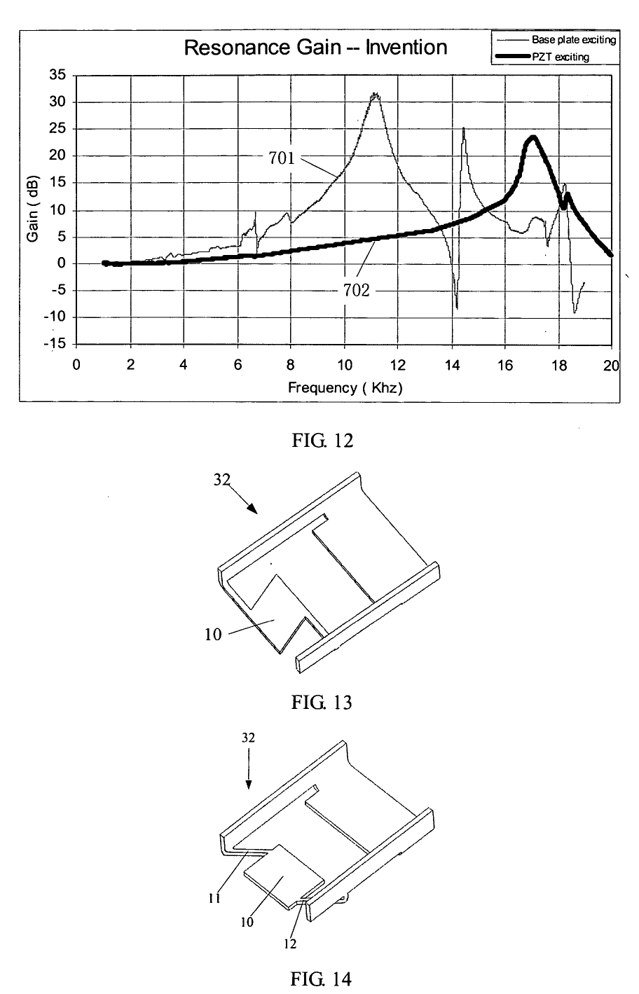

FIG. 12 show a testing result of the resonance performance of the HGA of the invention, here, 701 represents a base plate exciting resonance curve, and 702 represents a micro-actuator exciting resonance curve. It shows that a suspension resonance has not happened in a low frequency, but only a pure micro-actuator resonance happened in a high frequency when exciting the micro-actuator 32, this would enlarge the servo bandwidth and improve the capacity of the HDD, reduce the slider seeking and settling time.

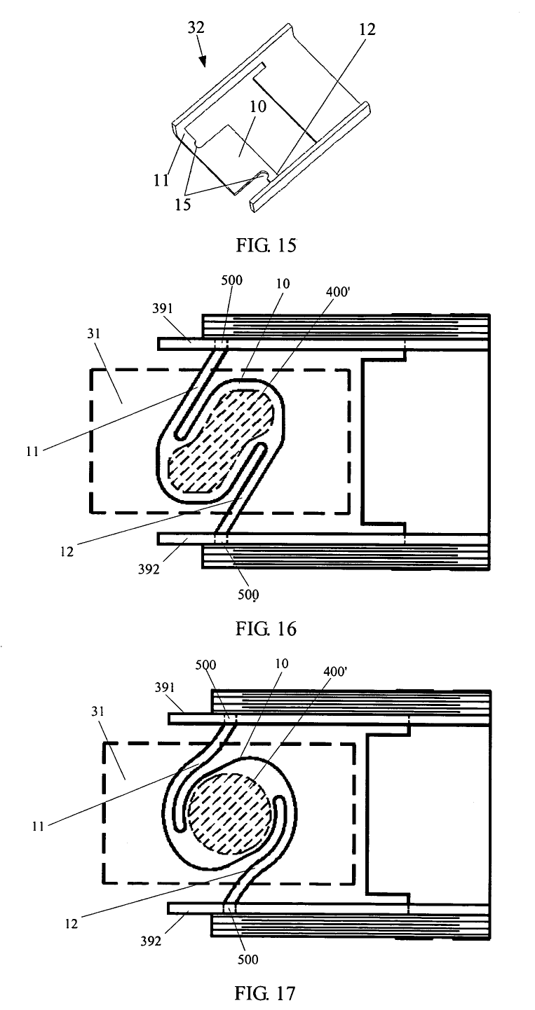

Referring to FIGS. 13-15, in the present invention, the support frame 32 can have other structures, for example, the support portion 10 has another shape (such as rhomboid) which is not cuboid-shaped. Selectively, the connection portions 11, 12 may be coupled to the support portion 10 in a predetermined coupling angle (not a 90 degree angle). In order to easily bend the connection portions 11, 12, a cut 15 can be provided between the connection portion 11 (12) and the support portion 10.

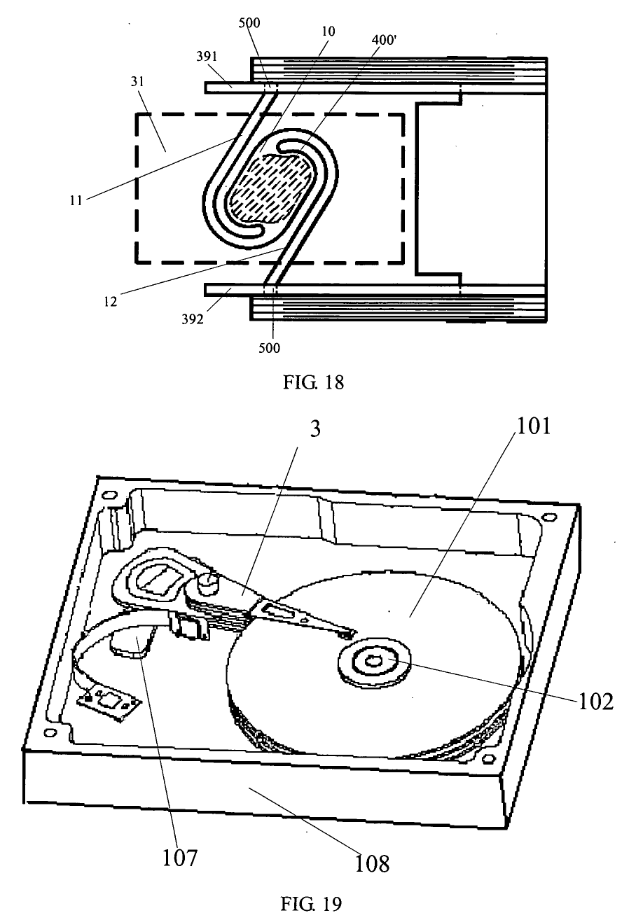

According to three embodiments of the invention, referring to FIGS. 16-18, the support portion 10 may be shaped with a contour constituted by smooth arcs. In addition, the connection portions 11, 12 may be curve-shaped. Furthermore, in order to keep balance of loading force exerted to the support portion 10, the connection portions 11, 12 are coupled with the side plates 391, 392 by two coupling points 500, which is symmetrically positioned with the longitude axis of the support frame as symmetry axis. In the present invention, the PZT pieces maybe mounted on one side or both sides of each of the side plates 391, 392.

In the present invention, referring to FIG. 19, a disk drive unit of the present invention can be attained by assembling a housing 108, a disk 101, a spindle motor 102, a VCM 107 with the HGA 3 of the present invention. Because the structure and/or assembly process of disk drive unit of the present invention are well known to persons ordinarily skilled in the art, a detailed description of such structure and assembly is omitted herefrom.

What is claimed is:

1. A head gimbal assembly comprising:
a slider;
a micro-actuator; which comprising a bottom plate, a moving plate, and two arm plates symmetrically disposed with an axis of the bottom plate as symmetry axis to connect the moving plate and the bottom plate; and at least one piezoelectric pieces to be bonded to the arm plates; and
a suspension to load the slider and the micro-actuator;
wherein the slider is mounted on and rotated by the moving plate when exciting the at least one piezoelectric pieces.

2. The head gimbal assembly as claimed in claim 1, wherein the moving plate comprises a support portion to support the slider, and two connection portions to connect with the support portion along a diagonal thereof.

3. The head gimbal assembly as claimed in claim 2, wherein each of the two connection portions has a narrower width than that of the support portion.

4. The head gimbal assembly as claimed in claim 2, wherein the slider is partially mounted on the support portion of the support frame, and the centers of the slider and the support portion are matched with each other.

5. The head gimbal assembly as claimed in claim 2, wherein two connection portions are coupled with the two arm plates by two coupling points, which is symmetrically positioned with a longitude axis of the support frame as symmetry axis.

6. The head gimbal assembly as claimed in claim 1, wherein the distance between the two arm plates is larger than the width of the slider.

7. The head gimbal assembly as claimed in claim 1, wherein the bottom plate is partially mounted to the suspension, and a parallel gap exists between the support frame and the suspension.

8. The head gimbal assembly as claimed in claim 1, wherein the arm plates are formed on two sides of both the bottom plate and the moving plate, and at least a space exist between the arm plate and the bottom plate or between the arm plate and the moving plate.

9. The head gimbal assembly as claimed in claim 1, wherein the at least one PZT pieces are mounted on one side or both sides of each of the arm plates.

10. The head gimbal assembly as claimed in claim 1, wherein the material to bond the slider with the support frame and the material to bond the bottom plate of the support frame with the suspension is epoxy, adhesive or ACF.

11. A micro-actuator comprising:
a bottom plate;
a moving plate for loading and rotating a slider;
two arm plates symmetrically disposed with an axis of the bottom plate as symmetry axis to connect the moving plate and the bottom plate; and
at least one piezoelectric pieces bonded to the two arm plates.

12. The micro-actuator as claimed in claim 11, wherein the moving plate comprises a support portion to support a slider, and two connection portions to connect with the support portion along a diagonal thereof.

13. The micro-actuator as claimed in claim 12, wherein each of the two connection portions has a narrower width than that of the support portion.

14. The micro-actuator as claimed in claim 11, wherein the at least one piezoelectric pieces are thin film piezoelectric pieces or ceramic piezoelectric pieces.

15. The micro-actuator as claimed in claim 11, wherein the at least one piezoelectric pieces have a single-layer structure or a multi-layer structure comprising a substrate layer and a piezoelectric layer.

16. The micro-actuator as claimed in claim 15, wherein the piezoelectric layer is a single-layer PZT structure or a multi-layer PZT structure, the substrate layer is made of metal, ceramic, or polymer.

17. The micro-actuator as claimed in claim 11, wherein the arm plates are formed on two sides of both the bottom plate and the moving plate, and at least a space exist between the arm plate and the bottom plate or between the arm plate and the moving plate.

18. The micro-actuator as claimed in claim 11, wherein the at least one PZT pieces are mounted on one side or both sides of each of the arm plates.

19. The micro-actuator as claimed in claim 11, wherein the material to bond the slider with the support frame is epoxy, adhesive or ACF.

20. A disk drive unit comprising:
a head gimbal assembly;
a drive arm to connect with the head gimbal assembly;
a disk; and
a spindle motor to spin the disk; wherein the head gimbal assembly comprising:
a slider;
a micro-actuator comprising a bottom plate, a moving plate, and two arm plates symmetrically disposed with an axis of the bottom plate as symmetry axis to connect the moving plate and the bottom plate; and at least one piezoelectric pieces to be bonded to the arm plates; and
a suspension to load the slider and the micro-actuator;
wherein the slider is mounted on and rotated by the moving plate when exciting the at least one piezoelectric pieces, the bottom plate is partially mounted on the suspension and a parallel gap exist between the support frame and the suspension therein.
